(19) United States
(12) Patent Application Publication
(10) Pub. No.: US 2025/0299628 A1
(43) Pub. Date: Sep. 25, 2025

(54) LOW POWER DISPLAY TIMING SYNCHRONIZATION BETWEEN SOC AND DISPLAY DRIVER INTEGRATED CIRCUIT

(71) Applicant: MEDIATEK INC., Hsinchu City (TW)

(72) Inventors: Tsung-Hsin CHEN, Hsinchu City (TW); Chin-Wen LIANG, Hsinchu City (TW)

(21) Appl. No.: 18/613,400

(22) Filed: Mar. 22, 2024

(51) Int. Cl. G09G 3/3208

(52) U.S. Cl. CPC G09G 3/3208; G09G 2310/08; G09G 2330/021; G09G 2370/08

(57) ABSTRACT

An electronic device includes a display controller, a clock generator, a multiplexer, and a processor. The display controller includes an interface, where the display controller provides a synchronization signal through the interface. The clock generator generates a clock signal. The multiplexer outputs either the synchronization signal or the clock signal as an output signal. When the processor needs to reduce power consumption of the display controller, the processor controls the multiplexer to output the clock signal as the output signal.

### BACKGROUND OF THE INVENTION

### Field of the Invention

The disclosure is generally related to an electronic device and a synchronization method thereof, and more particularly it is related to a synchronization method for an electronic device synchronizing with a display driver integrated circuit in a low power consumption.

### Description of the Related Art

As a self-emitting display device, an Organic Light Emitting Diode (OLED) device does not require an additional light source. Therefore, an OLED device can be driven by a low voltage and be easily fabricated to be light-weight and have a thin profile. In addition, the OLED device has the advantages of having a wide viewing angle, a high contrast and a high response speed. Therefore, the OLED device is widely used in various fields, such as in display devices of mobile phones, televisions, and computers, as well as foldable display devices.

At present, most OLED devices use Low Temperature Poly-silicon (0) Thin Film Transistor (TFT) panels. After the improvements of the past few years, the LTPS display panel has become the most mature and mainstream TFT panel solution on the market today due to its advantages of high resolution, a high response speed, and high brightness. Although the LTPS display panel has been welcomed by the market, it has the disadvantages of high production cost and large power consumption.

Therefore, an LTPO (Low Temperature Polycrystalline Oxide) display panel, which combines the LTPS display technology and the Oxide display (indium gallium zinc oxide, or IGZO) technology, has been developed. LTPO allows for more efficient use of power by dynamically adjusting the refresh rate of the screen based on the content being displayed. More specifically, LTPO can operate at a low refresh rate when displaying static content, such as images or text, but can operate at a higher refresh rate when displaying dynamic content, such as videos or games.

MIPI (Mobile Industry Processor Interface) is a set of standardized specifications for data communication interfaces in mobile devices such as mobile phones, cameras, electronic displays, embedded systems, radios, IoT devices, and many other components that require high bandwidth, low power consumption, and low electromagnetic interference. MIPI DSI (Display Serial Interface) is a specific subset of MIPI standards focused on the interface between display modules and processors in mobile devices. MIPI DSI operates in two primary modes: Command Mode and Video Mode. The Command Mode is designed for low-power operations, the frequent screen updates are not necessary. In contrast, the Video Mode continuously transmits pixel data, ensuring smooth video playback and dynamic content display and using the horizontal sync pulse (HSYNC) to keep signal synchronous.

However, when a display panel operates in low power application, its power consumption should be reduced as low as possible to lengthen the durability of the battery.

### BRIEF SUMMARY OF THE INVENTION

Electronic devices and synchronization methods are provided herein. Since the display controller is able to fully power off when the power consumption of the display controller 110 needs to be reduced, the power consumption of the display controller can be nearly eliminated. In addition, even though the display controller is fully deactivated, the synchronization between the electronic device and the display driver integrated circuit can be maintained by an additional clock signal, so that the synchronization between the electronic device and the display driver integrated circuit can be properly maintained.

In an embodiment, an electronic device is provided, which comprises a display controller, a clock generator, a multiplexer, and a processor. The display controller comprises an interface. The display controller provides a synchronization signal through the interface. The clock generator generates a clock signal. The multiplexer outputs either the synchronization signal or the clock signal as an output signal. When the processor needs to reduce power consumption of the display controller, the processor controls the multiplexer to outputs the clock signal as the output signal.

According to an embodiment of the present disclosure, the output signal is provided to a display driver integrated circuit. The display driver integrated circuit is configured to drive a display panel.

According to an embodiment of the present disclosure, when the processor does not need to reduce the power consumption of the display controller, the processor controls the multiplexer to output the synchronization signal as the output signal. The synchronization signal generated by the display controller synchronizes the display controller with the display driver integrated circuit.

According to an embodiment of the present disclosure, when the processor does not need to reduce the power consumption of the display controller, the display controller operates in an activated mode and generates the synchronization signal.

According to another embodiment of the present disclosure, when the processor needs to reduce the power consumption of the display controller, the display controller operates in a deactivated mode to reduce the power consumption. When the display controller is in the deactivated mode, the display controller stops generating the synchronization signal.

According to an embodiment of the present disclosure, the display controller, the clock generator, the multiplexer, and the processor are integrated in a package.

According to another embodiment of the present disclosure, the display controller and the processor are integrated in a package, and the clock generator and the package are integrated on a PCB.

According to an embodiment of the present disclosure, the synchronization signal is a horizontal synchronization signal.

According to an embodiment of the present disclosure, the interface is a mobile industry processor interface.

According to an embodiment of the present disclosure, when the processor needs to reduce the power consumption of the display controller, the processor operates in an Always On Display (AOD) mode or a Home Screen Idle mode.

In another embodiment, a synchronization method for an electronic device synchronizing with a display driver integrated circuit is provided. The electronic device comprises a display controller. The method comprises the following steps. It is determined whether power consumption of the display controller needs to be reduced. When it is determined that the power consumption of the display controller needs to be reduced, the display controller is deactivated. A clock signal is generated. The clock signal is provided to the display driver integrated circuit.

According to an embodiment of the present disclosure, the clock signal is generated by a clock generator.

According to an embodiment of the present disclosure, the clock generator and the display controller are integrated in a package.

According to another embodiment of the present disclosure, the clock generator and the display controller are integrated on a PCB.

According to an embodiment of the present disclosure, the synchronization method further comprises the following steps. When it is determined that the power consumption of the display controller does not need to be reduced, the display controller is activated. A synchronization signal is generated using the display controller. The synchronization signal is provided to the display driver integrated circuit.

According to an embodiment of the present disclosure, the synchronization signal is a horizontal synchronization signal.

According to an embodiment of the present disclosure, the synchronization signal is provided to the display driver integrated circuit through a mobile industry processor interface.

According to an embodiment of the present disclosure, the synchronization method further comprises the following steps. When it is determined that the power consumption of the display controller needs to be reduced, the display controller is deactivated.

According to an embodiment of the present disclosure, the synchronization signal is not generated when the display controller is deactivated.

According to an embodiment of the present disclosure, when it is determined that the power consumption of the display controller needs to be reduced, the electronic device is operated in an Always On Display (AOD) mode or a Home Screen Idle mode.

A detailed description is given in the following embodiments with reference to the accompanying drawings.

### BRIEF DESCRIPTION OF DRAWINGS

The present disclosure can be more fully understood by reading the subsequent detailed description and examples with references made to the accompanying drawings, wherein:

FIG. 1 is a block diagram of an electronic device in accordance with an embodiment of the present disclosure;

FIG. 2 is a block diagram of an electronic device in accordance with another embodiment of the present disclosure;

FIG. 3 is a block diagram of an electronic device in accordance with yet another embodiment of the present disclosure; and

FIG. 4 is a flow chart of a synchronization method in accordance with an embodiment of the present disclosure.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

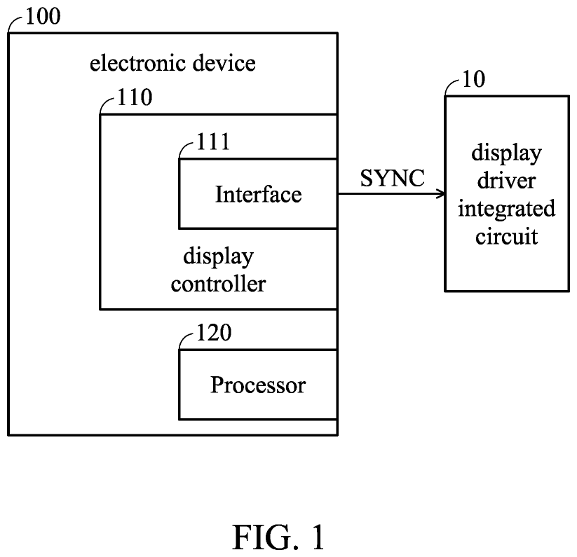

FIG. 1 is a block diagram of an electronic device in accordance with an embodiment of the present disclosure. As shown in FIG. 1, the electronic device 100 includes a display controller 110 and a processor 120. The display controller 110 includes an interface 111, where the display controller 110 provides a synchronization signal SYNC to a display driver integrated circuit 10 through the interface 111, so that the display controller 110 is synchronized with display driver integrated circuit 10.

According to some embodiments of the present disclosure, the interface 111 may be a mobile industry processor (MIPI) interface. As shown in FIG. 1, the display driver integrated circuit 10 is configured to drive a display panel (not shown in FIG. 1). According to an embodiment of the present disclosure, the synchronization signal SYNC may be a horizontal synchronization (HSYNC) signal.

According to an embodiment of the present disclosure, the display driver integrated circuit 10 may be configured to drive a video mode panel. According to another embodiment of the present disclosure, the display driver integrated circuit 10 may be configured to drive a LTPS panel. According to yet another embodiment of the present disclosure, the display driver integrated circuit 10 may be configured to drive a LTPO panel. According to yet another embodiment of the present invention, the display driver integrated circuit 10 may be configured to drive an OLED panel. According to other embodiments of the present disclosure, the display driver integrated circuit 10 may be configured to drive any type of panel that has or hasn't been developed.

The processor 120 determines whether to reduce the power consumption of the display controller 110. According to some embodiments of the present disclosure, the processor 120 executes a display driver to control the display controller 110 to drive the display driver integrated circuit 10, so as to drive the panel. According to an embodiment of the present disclosure, when the processor 120 does not need to reduce the power consumption of the display controller 110, the display controller 110 provides the synchronization signal SYNC to the display driver integrated circuit 10 through the interface 111. According to another embodiment of the present disclosure, when the electronic device 100 needs to reduce the power consumption of the display controller 110, the display controller 110 operates in a low power mode to reduce the overall power consumption.

However, when the display controller 110 operates in the low power mode, the display controller 110 still has to provide the synchronization signal SYNC to the display driver integrated circuit 10 for synchronization due to the specification. In other words, when the display controller 110 operates in the low power mode, the display controller 110 is not power off, so as to be able to provide the synchronization signal SYNC. Therefore, the power consumption of the display controller 110 can be further reduced when the electronic device 100 needs to reduce the power consumption of the display controller 110.

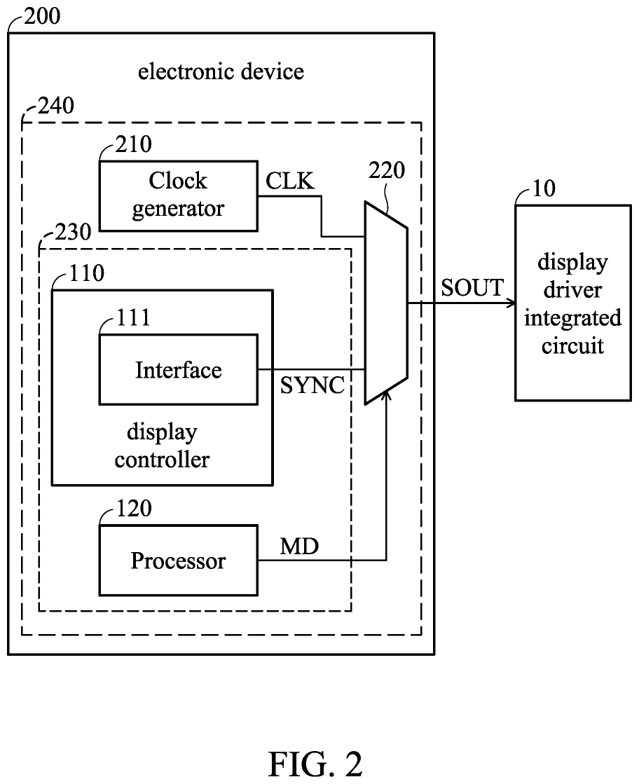

FIG. 2 is a block diagram of an electronic device in accordance with another embodiment of the present disclosure. Comparing the electronic device 200 to the electronic device 100 in FIG. 1, the electronic device 200 further includes a clock generator 210 and a multiplexer 220. The clock generator 210 generates a clock signal CLK. The multiplexer 220 outputs either the synchronization signal SYNC or the clock signal CLK as an output signal SOUT based on the mode signal MD.

According to an embodiment of the present disclosure, when the processor 120 operates in the normal mode, the processor 120 utilizes the mode signal MD to select the synchronization signal SYNC as the output signal SOUT. According to another embodiment of the present disclosure, when the processor 120 needs to reduce the power consumption of the display controller 110, the processor 120 utilizes the mode signal MD to select the clock signal CLK as the output signal SOUT.

According to an embodiment of the present disclosure, when the processor 120 does not need to reduce the power consumption of the display controller 110, the mode signal MD is in a first state. When the mode signal MD is in the first state, the multiplexer 220 outputs the synchronization signal SYNC as the output signal SOUT. According to another embodiment of the present disclosure, when the processor 120 needs to reduce the power consumption of the display controller 110, the mode signal MD is in a second state. When the mode signal MD is in the second state, the multiplexer 220 outputs the clock signal CLK as the output signal SOUT.

According to an embodiment of the present disclosure, since the processor 120 selects the clock signal CLK as the output signal SOUT when the processor 120 needs to reduce the power consumption of the display controller 110, the display controller 110 stops generating the synchronization signal SYNC and is able to power off so as to reduce the power consumption as much as possible. In other words, when the processor 120 needs to reduce the power consumption of the display controller 110, the display controller 110 operates in a deactivated mode to be power off. When the processor 120 does not need to reduce the power consumption of the display controller 110, the display controller 110 operates in an activated mode to perform maximum functionality.

According to an embodiment of the present disclosure, when the display controller 110 operates in the deactivated mode, the power consumption of the display controller 110 can be nearly eliminated.

According to an embodiment of the present disclosure, when the processor 120 does not need to reduce the power consumption of the display controller 110, the electronic device 200 may drive the display panel that is driven by the display driver integrated circuit 10 to display dynamic content, such as videos or games. According to another embodiment of the present disclosure, when the processor 120 needs to reduce the power consumption of the display controller 110, the electronic device may drive the display panel that is driven by the display driver integrated circuit 10 to display static content, such as images or text.

According to some embodiments of the present disclosure, when the processor 120 needs to reduce the power consumption of the display controller 110, the processor 120 may operate in an Always On Display (AOD) mode. The AOD mode is a smartphone feature that has the smartphone continue to show limited information while the smartphone is asleep. According to some embodiments of the present disclosure, when the processor 120 needs to reduce the power consumption of the display controller 110, the processor 120 may operate in Home Screen Idle mode (or Home Screen when idle). According to some embodiments of the present disclosure, when the processor 120 needs to reduce the power consumption of the display controller 110, the electronic device 100 may operate as an eBook (i.e., a user uses the electronic device 100 to execute eBook or ePub reader for reading).

As shown in FIG. 2, the display controller 110 and the processor 120 are integrated in a first package 230. The first package 230, the clock generator 210, and the multiplexer 220 are mounted on a printed circuit board 240. In other words, the clock generator 210 and the display controller 110 are physically separated from each other.

According to an embodiment of the present disclosure, the display controller 110 and the processor 120 may be integrated as System on a Chip (SoC). According to another embodiment of the present disclosure, the display controller 110 and the processor 120 may be integrated as System in Package (SiP). According to yet another embodiment of the present disclosure, the display controller 110 and the processor 120 may be integrated as three-dimensional integrated circuit (3D IC).

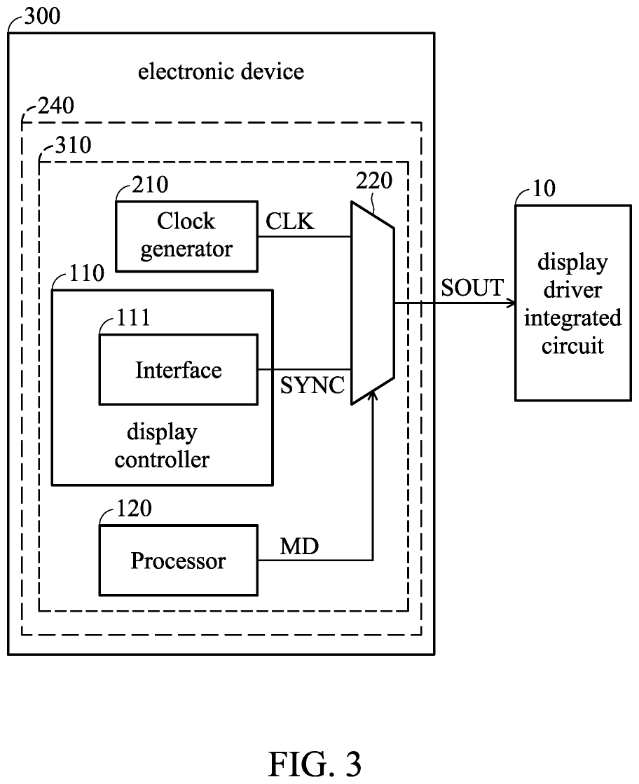

FIG. 3 is a block diagram of an electronic device in accordance with yet another embodiment of the present disclosure. Comparing the electronic device 300 with the electronic device 200 in FIG. 2, the display controller 110, the processor 120, the clock generator 210, and the multiplexer 220 are integrated in a second package 310.

According to an embodiment of the present disclosure, the clock generator 210 integrated with the display controller 110 the processor 120, and the multiplexer 220 may be a clock source of the second package 310, where the clock source is configured to generate clock signals of the General Purpose Input/Output (GPIO).

According to some embodiments of the present disclosure, since the display controller 110, the processor 120, the clock generator 210 and the multiplexer 220 are integrated in the second package 310, the clock signal CLK may be output through a pin of the second package 310. Then, the multiplexer 220 selects the clock signal CLK or the synchronization signal SYNC as the output signal SOUT based on the mode signal MD.

According to other embodiments of the present disclosure, the display controller 110, the processor 120, the clock generator 210, and the multiplexer 220 may be integrated in the same package as a SoC, SIP or 3D IC. Accordingly, the electronic device 300 provides the synchronization signal SYNC to the display driver integrated circuit 10 when the processor 120 does not need to reduce the power consumption of the display controller 110, and provides the clock signal CLK to the display driver integrated circuit 10 when the processor 120 needs to reduce the power consumption of the display controller 110 for allowing the display controller 110 to be completely powered off.

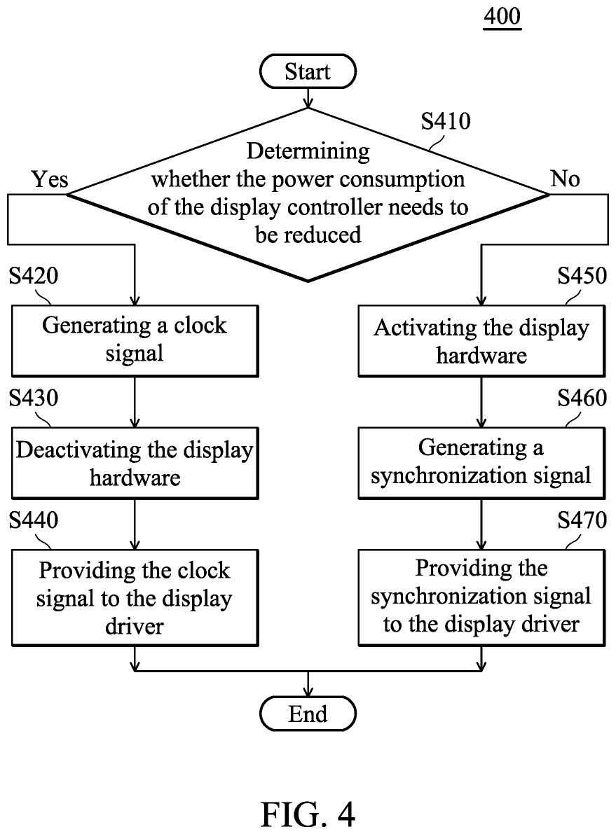

FIG. 4 is a flow chart of a synchronization method in accordance with an embodiment of the present disclosure. In the following description, the synchronization method 400 will be described with the electronic device 200 in FIG. 2 and the electronic device 300 in FIG. 3 for further detailed explanation.

It is determined that whether the power consumption of the display controller 110 needs to be reduced (Step S410). According to an embodiment of the present disclosure, when the power consumption of the display controller 110 needs to be reduced, the display panel driven by the display driver integrated circuit 10 displays static content, such as images or text. According to another embodiment of the present disclosure, when the power consumption of the display controller 110 does not need to be reduced, the display panel driven by the display driver integrated circuit 10 displays dynamic content, such as videos or games.

Then, the clock signal CLK is generated (Step S420). According to an embodiment of the present disclosure, as shown in FIG. 2, the clock signal CLK is generated by the clock generator 210, and the clock generator 210 is separated from the first package 230 integrating the display controller 110 and the processor 120. According to another embodiment of the present disclosure, as shown in FIG. 3, the display controller 110, the processor 120, and the clock generator 210 are integrated in the second package 310, where the clock generator 210 in FIG. 3 is the clock source in the electronic device 310 for generating clock signals of the General Purpose Input/Output (GPIO).

When it is determined that the power consumption of the display controller 110 needs to be reduced, the display controller 110 is deactivated (Step S430), so that the power consumption of the display controller 110 can be nearly eliminated. According to an embodiment of the present disclosure, when the display controller 110 is deactivated, the display controller 110 is completely powered off so as to reduce the power consumption of the display controller 110 can be nearly eliminated. According to another embodiment of the present disclosure, when the display controller 110 is deactivated, the display controller 110 operates in low power mode, so as to reduce the power consumption of the display controller 110.

After the clock signal CLK is generated, the multiplexer 220 provides the clock signal CLK to the display driver integrated circuit 10 (Step S440). As shown in FIG. 2 and FIG. 3, the multiplexer 220 selects the clock signal CLK as the output signal SOUT based on the mode signal MD, and provides the output signal SOUT to the display driver integrated circuit 10. According to some embodiments of the present disclosure, the mode signal MD indicates that the electronic device 200 or the electronic device 300 operates in the low power mode or the normal mode.

Referring to Step S410, when it is determined that the power consumption of the display controller 110 does not need to be reduced, the display controller 110 is activated (Step S450). According to an embodiment of the present disclosure, when the power consumption of the display controller 110 does not need to be reduced, the display panel driven by the display driver integrated circuit 10 displays dynamic content, such as videos or games.

After the display controller 110 is activated, the display controller 110 generates the synchronization signal SYNC (Step S460). After the synchronization signal SYNC is generated, the multiplexer 220 provides the synchronization signal SYNC to the display driver integrated circuit 10 (Step S470) for synchronization.

Electronic devices and synchronization methods are provided herein. Since the display controller is able to fully power off when the power consumption of the display controller 110 needs to be reduced, the power consumption of the display controller can be nearly eliminated. In addition, even though the display controller is fully deactivated, the synchronization between the electronic device and the display driver integrated circuit can be maintained by an additional clock signal, so that the synchronization between the electronic device and the display driver integrated circuit can be properly maintained.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An electronic device, comprising:
a display controller, comprising an interface, wherein the display controller provides a synchronization signal through the interface;
a clock generator, generating a clock signal;
a multiplexer, outputting either the synchronization signal or the clock signal as an output signal; and
a processor, wherein when the processor needs to reduce power consumption of the display controller, the processor controls the multiplexer to output the clock signal as the output signal.

2. The electronic device as defined in claim 1, wherein the output signal is provided to a display driver integrated circuit;
wherein the display driver integrated circuit is configured to drive a display panel.

3. The electronic device as defined in claim 2, wherein when the processor does not need to reduce the power consumption of the display controller, the processor controls the multiplexer to output the synchronization signal as the output signal;
wherein the synchronization signal generated by the display controller synchronizes the display controller with the display driver integrated circuit.

4. The electronic device as defined in claim 3, wherein when the processor does not need to reduce the power consumption of the display controller, the display controller operates in an activated mode and generates the synchronization signal.

5. The electronic device as defined in claim 1, wherein when the processor needs to reduce the power consumption of the display controller, the display controller operates in a deactivated mode to reduce the power consumption;
wherein when the display controller is in the deactivated mode, the display controller stops generating the synchronization signal.

6. The electronic device as defined in claim 1, wherein the display controller, the clock generator, the multiplexer, and the processor are integrated in a package.

7. The electronic device as defined in claim 1, wherein the display controller and the processor are integrated in a package, and the clock generator and the package are integrated on a PCB.

8. The electronic device as defined in claim 1, wherein the synchronization signal is a horizontal synchronization signal.

9. The electronic device as defined in claim 1, wherein the interface is a mobile industry processor interface.

10. The electronic device as defined in claim 1, wherein when the processor needs to reduce the power consumption of the display controller, the processor operates in an Always On Display (AOD) mode or a Home Screen Idle mode.

11. A synchronization method for an electronic device synchronizing with a display driver integrated circuit, wherein the electronic device comprises a display controller, wherein the method comprises:
determining whether power consumption of the display controller needs to be reduced;
when it is determined that the power consumption of the display controller needs to be reduced, deactivating the display controller;
generating a clock signal; and
providing the clock signal to the display driver integrated circuit.

12. The synchronization method as defined in claim 11, wherein the clock signal is generated by a clock generator.

13. The synchronization method as defined in claim 12, wherein the clock generator and the display controller are integrated in a package.

14. The synchronization method as defined in claim 12, wherein the clock generator and the display controller are integrated on a PCB.

15. The synchronization method as defined in claim 11, further comprising:
when it is determined that the power consumption of the display controller does not need to be reduced, activating the display controller;
generating a synchronization signal using the display controller; and
providing the synchronization signal to the display driver integrated circuit.

16. The synchronization method as defined in claim 15, wherein the synchronization signal is a horizontal synchronization signal.

17. The synchronization method as defined in claim 15, wherein the synchronization signal is provided to the display driver integrated circuit through a mobile industry processor interface.

18. The synchronization method as defined in claim 11, further comprising:
when it is determined that the power consumption of the display controller needs to be reduced, deactivating the display controller.

19. The synchronization method as defined in claim 18, wherein the synchronization signal is not generated when the display controller is deactivated.

20. The synchronization method as defined in claim 11, wherein when it is determined that the power consumption of the display controller needs to be reduced, the electronic device is operated in an Always On Display (AOD) mode or a Home Screen Idle mode.
